(19) United States
(12) Patent Application Publication
(10) Pub. No.: US 2004/0232817 A1
(43) Pub. Date: Nov. 25, 2004

(54) Electron gun and cathode ray tube device

(75) Inventors: Hiroshi Hasegawa, Kashihara-shi (JP); Akira Hayashi, Suita-shi (JP); Hiroyuki Tomoyasu, Ibaraki-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 10/826,898

(22) Filed: Apr. 16, 2004

(30) Foreign Application Priority Data
May 20, 2003 (JP) 2003-141744

(51) Int. Cl. H01J 29/70; H01J 29/50; H01J 29/46

(52) U.S. Cl. 313/414; 313/409; 313/452

(57) ABSTRACT

An electron gun includes a first focusing electrode and a second focusing electrode that are disposed so as to face each other and supplied with equal electric potentials. An electron beam passing aperture provided in at least one of a surface of the first focusing electrode facing the second focusing electrode and a surface of the second focusing electrode facing the first focusing electrode is a single opening common to three electron beams. Much of the magnetic flux from a scanning velocity modulation coil provided on outer peripheral surface of a neck portion of a funnel crosses this single opening. Thus, the scanning velocity modulation (SVM) sensitivity improves.

### BACKGROUND OF THE INVENTION

1. Field of the Invention

The present invention relates to an electron gun and a cathode ray tube device. In particular, the present invention relates to a cathode ray tube device whose neck portion is provided with a scanning velocity modulation coil and an electron gun that can be used preferably in this cathode ray tube device.

2. Description of Related Art

FIG. 1 is a sectional side view showing a cathode ray tube device. As shown in FIG. 1, the cathode ray tube device includes a cathode ray tube, a deflection yoke 5, a convergence yoke 6 and a scanning velocity modulation coil (in the following, referred to as an “SVM coil”) 7. The cathode ray tube includes a funnel 2, an electron gun 4 provided inside a neck portion 3 of the funnel 2 and a front panel 1 whose inner surface is provided with a phosphor screen 8. The deflection yoke 5 is provided on an outer surface of the funnel 2 and on the side of the front panel 1 with respect to the electron gun 4. The convergence yoke 6 and the SVM coil 7 are provided outside the neck portion 3.

FIG. 2 is a sectional side view showing the neck portion 3, with the electron gun being shown as a side view. FIG. 3 is a perspective view showing the electron gun. The electron gun 4 includes three cathodes 10, a control electrode 11, an accelerating electrode 12, a first focusing electrode 17, a second focusing electrode 18, an anode electrode 19 and a top unit electrode 20 in this order. The deflection yoke 5 mounted on a cone portion of the funnel 2 includes a horizontal deflection coil 21 for deflecting three electron beams 9 (see FIG. 1) in a horizontal direction and a vertical deflection coil 22 for deflecting these electron beams in a vertical direction. The deflection yoke 5 generates an alternating current magnetic field so as to deflect horizontally and vertically the electron beams 9 emitted from the cathodes 10, thus allowing them to scan the phosphor screen 8. The convergence yoke 6 is mounted outside the neck portion 3 and generates a magnetic field for adjusting convergence of the three electron beams 9.

Furthermore, in order to improve image sharpness, the cathode ray tube device currently includes the SVM coil 7 outside the neck portion 3. As shown in FIG. 2, the SVM coil 7 is disposed between the convergence yoke 6 and the neck portion 3 in a direction perpendicular to a tube axis and at a position overlapping the first focusing electrode 17, the second focusing electrode 18 and the anode electrode 19 in a tube axis direction. The SVM coil 7 generates a substantially vertical magnetic field 23 according to a video signal so as to modulate a horizontal scanning velocity of the electron beams, thereby emphasizing a border of a high brightness portion and a low brightness portion on the phosphor screen 8, so that the sharpness of the image can be improved (see JP 10(1998)-74465A, for example).

For preventing the magnetic field from interfering with the deflection yoke 5, the SVM coil 7 generally is disposed at substantially the same position along the tube axis direction as the first focusing electrode 17, the second focusing electrode 18 and the anode electrode 19. Further, the magnetic field 23 for modulating the scanning velocity of the electron beams has a frequency equal to or higher than the video signal (on the order of MHz). Accordingly, the magnetic field 23 generated by the SVM coil 7 is blocked by the first focusing electrode 17, the second focusing electrode 18 and the anode electrode 19 that are formed of a metallic material such as stainless steel or attenuated considerably by an eddy current generated on the surfaces of these electrodes. As the frequency of the scanning velocity modulation magnetic field 23 becomes higher, it becomes more difficult to exert a desired effect of modulating the scanning velocity (in the following, referred to as an “SVM effect”) on the electron beams passing inside the electrodes. Therefore, it conventionally has been suggested that the electrode that is press-formed into a cup shape is divided into several portions so that more gaps are provided between these portions, thereby improving permeability of the magnetic field 23 (see JP 8(1996)-115684 A, for example).

However, providing more gaps by dividing the electrode part and expanding these gaps as above not only improve the SVM effect but also cause a considerable problem that an electric field generated by an electrically charged inner wall of the neck portion 3 permeates into the electrode part, thus affecting the convergence characteristics of the three electron beams. Also, the division of the electrode part increases the number of parts and assembling processes, causing the deterioration of assembling accuracy and increasing the components and assembling costs. Moreover, when the electrode is divided within a limited space, the height (the length along the tube axis direction) of individual electrode parts cannot be secured sufficiently, so that the distance between the electrodes forming the electric fields of a main lens and a quadrupole lens and the divided electrodes is reduced, adversely affecting the electric field of the lenses.

### SUMMARY OF THE INVENTION

It is an object of the present invention to provide an electron gun capable of improving an SVM sensitivity without dividing electrode parts or expanding the gaps between the electrode parts. It is a further object of the present invention to provide a cathode ray tube device in which the SVM sensitivity is improved, achieving a sharper image.

An electron gun according the present invention includes cathodes, a control electrode, an accelerating electrode, a first focusing electrode, a second focusing electrode facing the first focusing electrode via a gap, and an anode electrode. The first focusing electrode and the second focusing electrode are supplied with equal electric potentials. The cathodes, the control electrode, the accelerating electrode, the first focusing electrode, the second focusing electrode and the anode electrode are disposed in this order, and an electron beam passing aperture provided in at least one of a surface of the first focusing electrode facing the second focusing electrode and a surface of the second focusing electrode facing the first focusing electrode is a single opening common to three electron beams.

A cathode ray tube device according to the present invention includes a cathode ray tube and a scanning velocity modulation coil. The cathode ray tube includes an envelope having a front panel and a funnel, and an electron gun inside a neck portion of the funnel. The electron gun has a first focusing electrode and a second focusing electrode facing the first focusing electrode via a gap, and the first focusing electrode and the second focusing electrode are supplied with equal electric potentials. The scanning velocity modulation coil is provided on an outer surface of the neck portion and near the first focusing electrode and the second focusing electrode. An electron beam passing aperture provided in at least one of a surface of the first focusing electrode facing the second focusing electrode and a surface of the second focusing electrode facing the first focusing electrode is a single opening common to three electron beams.

### BRIEF DESCRIPTION OF THE DRAWINGS

FIG. 1 is a sectional side view showing an exemplary cathode ray tube device.

FIG. 2 is a sectional side view showing a neck portion.

FIG. 3 is a perspective view showing a conventional electron gun.

FIG. 4A is a front view showing a surface of a first focusing electrode facing a second focusing electrode in the conventional electron gun, and FIG. 4B is a front view showing a surface of the second focusing electrode facing the first focusing electrode in the conventional electron gun.

FIG. 5 is a perspective view showing an electron gun according to a first embodiment of the present invention.

FIG. 6A is a front view showing a surface of a first focusing electrode facing a second focusing electrode in the electron gun according to the first embodiment of the present invention, and FIG. 6B is a front view showing a surface of the second focusing electrode facing the first focusing electrode in the electron gun according to the first embodiment of the present invention.

FIG. 7 is a front view showing a magnetic flux in the surface of the first focusing electrode facing the second focusing electrode in the conventional electron gun.

FIG. 8 is a front view showing a magnetic flux in the surface of the first focusing electrode facing the second focusing electrode in the electron gun according to the first embodiment of the present invention.

FIG. 9 is a graph showing an effect of modulating a scanning velocity (an SVM sensitivity).

FIG. 10 is a perspective view showing an embodiment of an electron gun of a dynamic focus type in the present invention.

FIG. 11 is a perspective view showing another embodiment of the electron gun of the dynamic focus type in the present invention.

FIG. 12A is a front view showing a surface of a first focusing electrode facing a second focusing electrode in an electron gun according to a second embodiment of the present invention, and FIG. 12B is a front view showing a surface of the second focusing electrode facing the first focusing electrode in the electron gun according to the second embodiment of the present invention.

FIG. 13 is a perspective view showing an electrode part of a focusing electrode constituting an electron gun according to a third embodiment of the present invention.

FIG. 14 is a front view showing an electrode surface of an electrode part of a focusing electrode constituting an electron gun according to a fourth embodiment of the present invention.

FIG. 15 is a front view showing an electrode surface of an electrode part of a focusing electrode constituting an electron gun according to a fifth embodiment of the present invention.

FIG. 16 is a perspective view showing an exemplary jig used when assembling the electron gun of the present invention.

FIG. 17 is a sectional view showing an exemplary process of assembling the electron gun of the present invention.

### DESCRIPTION OF THE PREFERRED EMBODIMENTS

In accordance with the present invention, it becomes possible to exert the magnetic field from a scanning velocity modulation coil effectively on the position where three electron beams pass, thus achieving a desired effect of modulating the scanning velocity of the electron beams. Thus, a larger scanning velocity modulation effect over a wide frequency range can be obtained compared with the conventional electron gun, so that the sharpness of an image of the cathode ray tube can be improved.

In the above-described electron gun according to the present invention, it is preferable that an electron beam passing aperture provided in both of the surface of the first focusing electrode facing the second focusing electrode and the surface of the second focusing electrode facing the first focusing electrode is a single opening common to three electron beams. This configuration allows a magnetic field generated by the scanning velocity modulation coil to act on the electron beams still more effectively, thus achieving the desired effect of modulating a scanning velocity of the electron beams.

It also is preferable that the first focusing electrode or the second focusing electrode provided with the single opening has a tubular wall surface surrounding the three electron beams, and a hole is provided in lateral surface portions in the wall surface that intersect a horizontal axis. This configuration allows the magnetic field generated by the scanning velocity modulation coil to act on the electron beams still more effectively, thus achieving a desired effect of modulating the scanning velocity of the electron beams.

Further, it is preferable that a vertical width of the single opening near positions through which the three electron beams pass is smaller than that at the other positions. This configuration allows the magnetic field generated by the scanning velocity modulation coil to act on the electron beams still more effectively, thus achieving a desired effect of modulating the scanning velocity of the electron beams.

Moreover, it is preferable that both ends of the single opening in a horizontal direction have a circular arc shape. This configuration makes it possible to position the components accurately using an assembling jig with circular cylinders, which can be produced relatively easily, in the process of assembling the electron gun.

The following is a description of an electron gun and a cathode ray tube device according the present invention, with reference to the accompanying drawings.

### First Embodiment

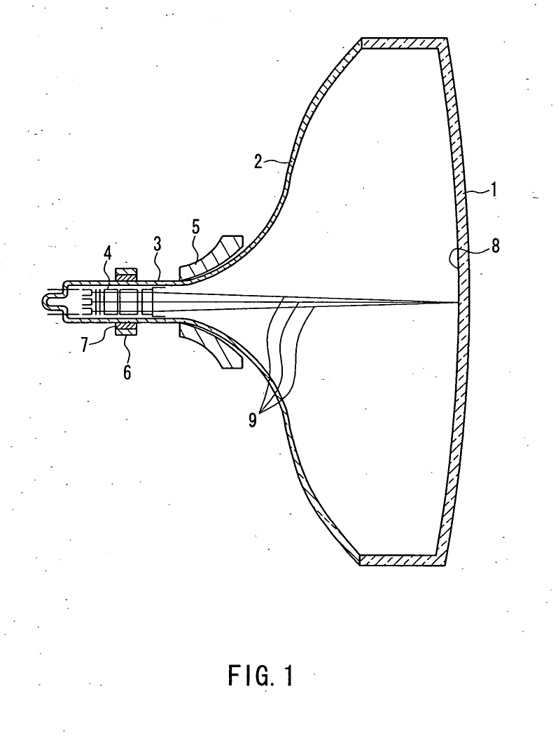

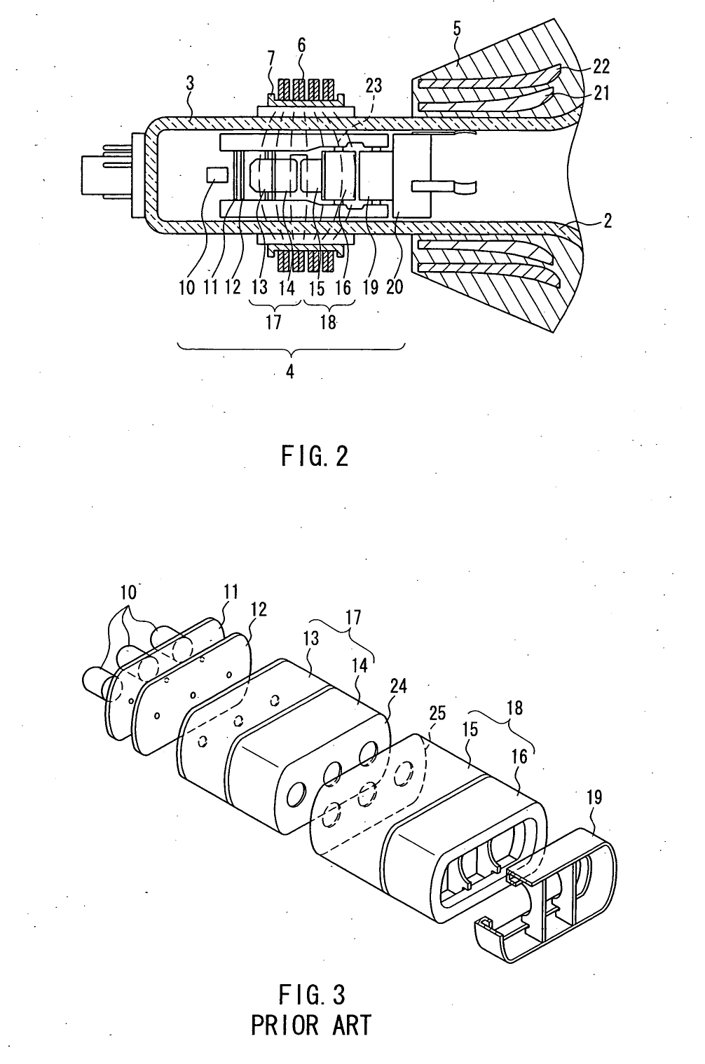

As shown in FIG. 1, a cathode ray tube device includes a cathode ray tube, a deflection yoke 5, a convergence yoke 6 and an SVM coil 7. The cathode ray tube includes a funnel 2, an electron gun 4 provided inside a neck portion 3 of the funnel 2 and a front panel 1 whose inner surface is provided with a phosphor screen 8. The deflection yoke 5 is provided on an outer surface of the funnel 2 and on the side of the front panel 1 with respect to the electron gun 4. The convergence yoke 6 is provided outside the neck portion 3, and the SVM coil 7 is provided between the convergence yoke 6 and the neck portion 3.

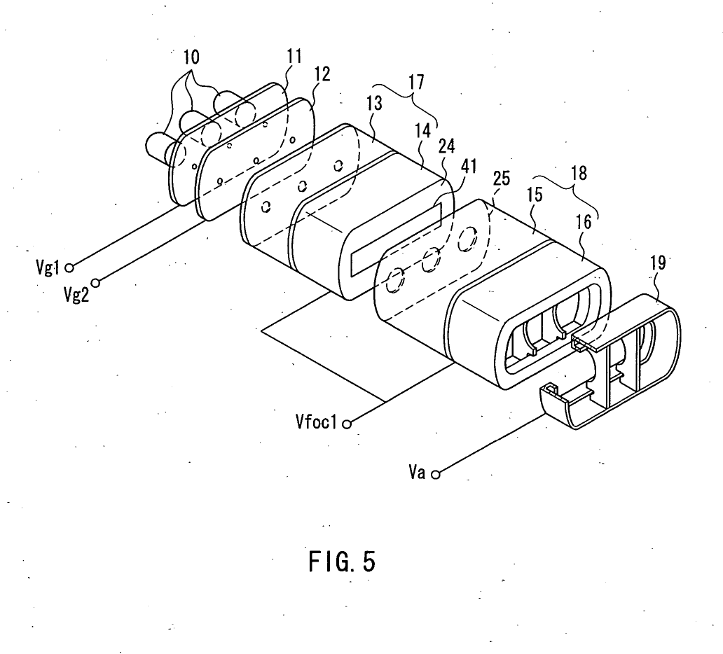

Next, an electron gun according the present invention will be described referring to an external view of FIG. 5. The electron gun 4 of the present invention includes three cathodes 10, a control electrode 11, an accelerating electrode 12, a first focusing electrode 17, a second focusing electrode 18 and an anode electrode 19 in this order. A gap is provided between the first focusing electrode 17 and the second focusing electrode 18. The control electrode 11 is supplied with an electric potential Vg1, the accelerating electrode 12 is supplied with an electric potential Vg2, the first focusing electrode 17 and the second focusing electrode 18 are supplied with equal electric potentials Vfoc1, and the anode electrode 19 is supplied with an electric potential Va. A prefocus lens is formed between the accelerating electrode 12 and the first focusing electrode 17, while a main lens is formed between the second focusing electrode 18 and the anode electrode 19. The first focusing electrode 17 is constituted by an electrode part 13 and an electrode part 14, which are both cup-like electrodes, and the second focusing electrode 18 is constituted by an electrode part 15 and an electrode part 16, which are both cup-like electrodes.

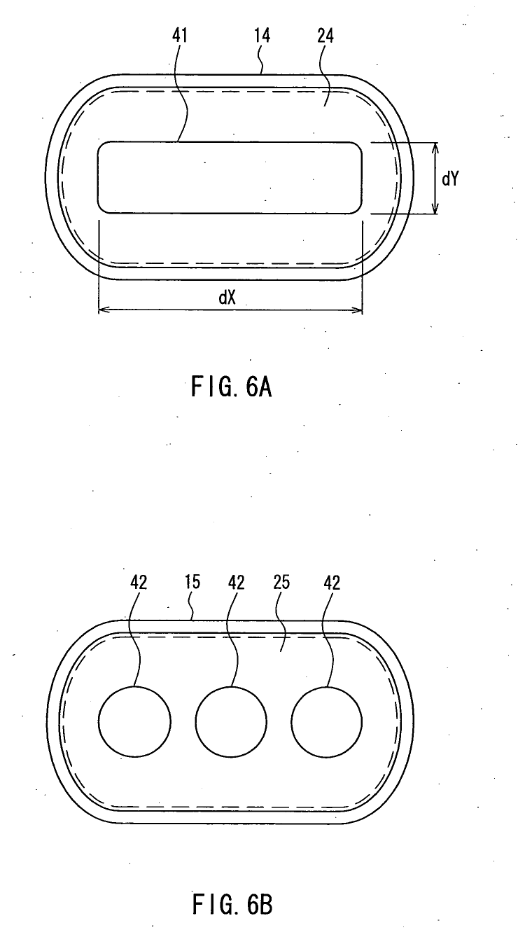

FIG. 6A is a front view showing a surface of the first focusing electrode 17 facing the second focusing electrode 18 (a bottom surface 24 of the cup-like electrode part 14), while FIG. 6B is a front view showing a surface of the second focusing electrode 18 facing the first focusing electrode 17 (a bottom surface 25 of the cup-like electrode part 15). In the electrode part 14 of the first focusing electrode 17, an opening 41 formed in the electrode surface 24 facing the second focusing electrode 18 is a horizontally elongated single opening common to the three electron beams. On the other hand, in the electrode part 15 of the second focusing electrode 18, the electrode surface 25 facing the first focusing electrode 17 is provided with three electron beam passing apertures 42 that are independent of one another.

As shown in FIG. 5, the control electrode 11, the accelerating electrode 12, the surface of the first focusing electrode 17 facing the accelerating electrode 12, the surface of the second focusing electrode 18 facing the anode electrode 19 and the surface of the anode electrode 19 facing the second focusing electrode 18 respectively are provided with three electron beam passing apertures that are independent of one another. The opposing surfaces of the second focusing electrode 18 and the anode electrode 19 forming the main lens are each provided with three electron beam passing apertures that are independent of one another. Those apertures are provided by arranging two plate members parallel with the vertical direction at positions retracted inward from an opening plane of the horizontally elongated single opening.

In the following, the principle of improving the SVM sensitivity according to the present invention will be described.

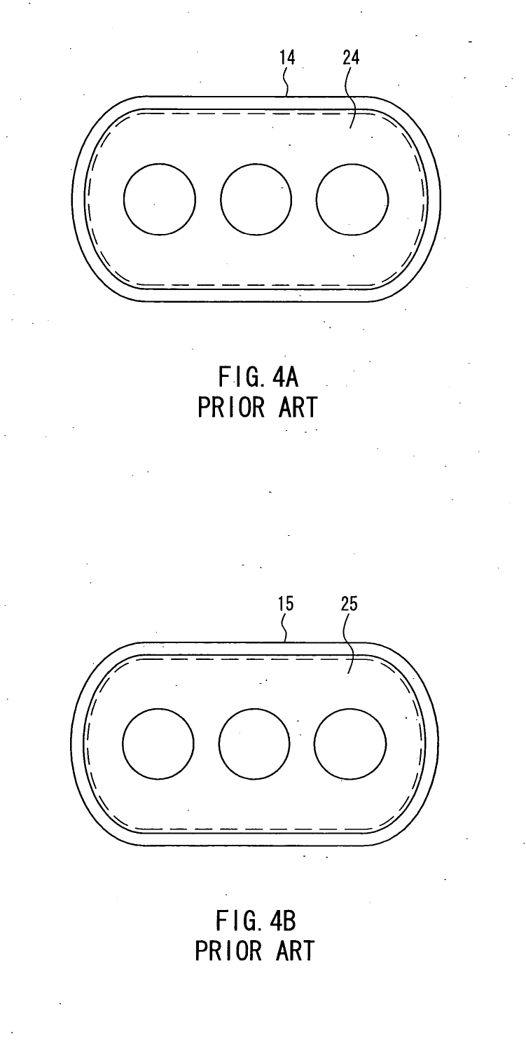

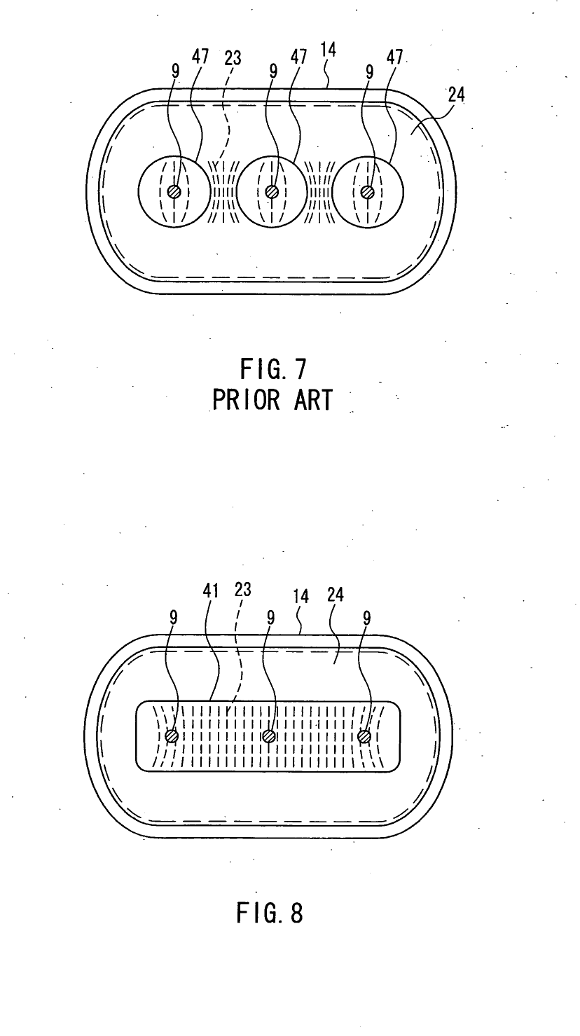

As shown in FIG. 4A and FIG. 7, an electrode surface 24 of an electrode part 14 facing an electrode part 15 conventionally has been provided with three electron beam passing apertures 47 that are independent of one another. In contrast, as shown in FIG. 6A and FIG. 8, the electrode surface 24 in the present invention is provided with the single opening 41 common to the three electron beams.

In the conventional case where the electrode surface 24 is provided with the three independent electron beam passing apertures 47 as shown in FIG. 7, most of the magnetic flux 23 generated by the SVM coil 7 passes inside a metal portion with a low magnetic resistance in the electrode surface 24. Thus, only a slight magnetic flux crosses the three electron beam passing apertures 47 and acts on the electron beams 9.

On the other hand, in the case of the present invention where the electrode surface 24 is provided with the single opening 41 common to the three electron beams 9 as shown in FIG. 8, the metal portion is much smaller compared with the conventional case. Therefore, in the magnetic flux 23, a part passing inside the metal portion in the electrode surface 24 decreases, while a part crossing the single opening 41 and acting on the electron beams 9 increases considerably, compared with the case of FIG. 7. As a result, the SVM effect improves greatly.

### EXAPMPLE

The following is an example of the present invention.

The control electrode 11 was supplied with a voltage of 0 V, the accelerating electrode 12 was supplied with a voltage of 400 to 1000 V, the first focusing electrode 17 and the second focusing electrode 18 were supplied with equal voltages of about 5 to 10 kV, and the anode electrode 19 was supplied with a voltage of about 20 to 35 kV. The electrode parts 13 and 14 of the first focusing electrode 17 had a height (a length along the tube axis direction) of 6.2 mm and 10.2 mm, respectively. The electrode parts 15 and 16 of the second focusing electrode 18 both had a height of 4.7 mm. The electron beam passing aperture 41 provided in the electrode surface 24 of the electrode part 14 of the first focusing electrode 17 was a single opening having a horizontal width dX of 16.6 mm and a vertical width dY of 5.6 mm. The first focusing electrode 17 and the second focusing electrode 18 were spaced apart by 1.0 mm, and connected by an electrically conductive ribbon so as to be supplied with equal electric potentials.

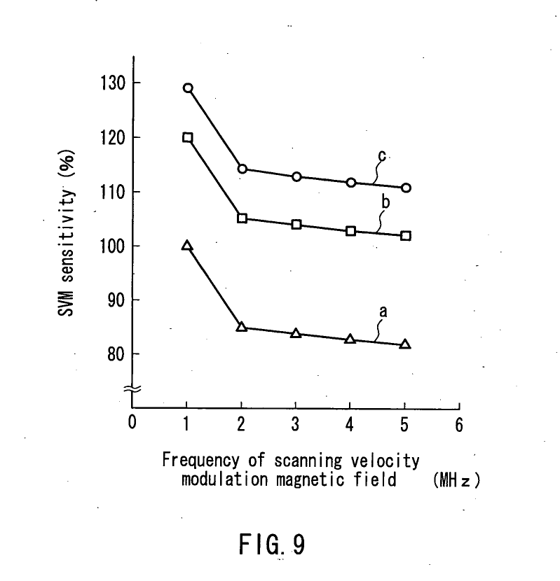

The effects of the present invention will be discussed referring to FIG. 9, which shows the relationship between the frequency of the scanning velocity modulation magnetic field and the SVM sensitivity. The “SVM sensitivity” of the ordinate axis in FIG. 9 refers to a relative amount of horizontal variation of an electron beam landing spot on the phosphor screen 8 when a constant electric current is passed through the SVM coil 7. As this value becomes larger, the electron gun has a higher sensitivity to the variation in the electron beam path with respect to the scanning velocity modulation magnetic field. In FIG. 9, a curve a indicates the experimental result of a conventional cathode ray tube device whose electrode surface 24 is provided with the three independent electron beam passing apertures 47, while a curve b indicates that of a cathode ray tube device according to the above-described example of the present invention whose electrode surface 24 is provided with the single opening 41 serving as the electron beam passing aperture common to the three electron beams. As becomes clear from the graph of FIG. 9, the curve b achieved a higher SVM sensitivity than the curve a at all frequencies.

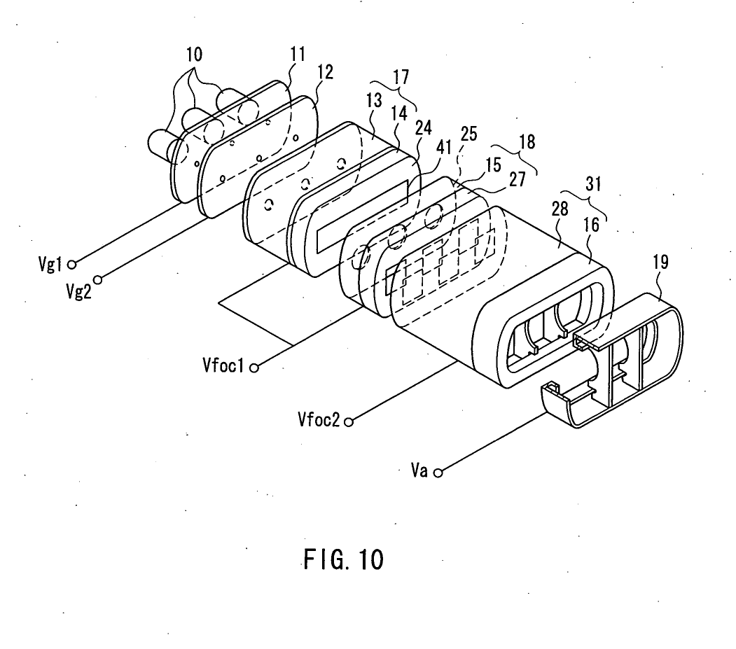

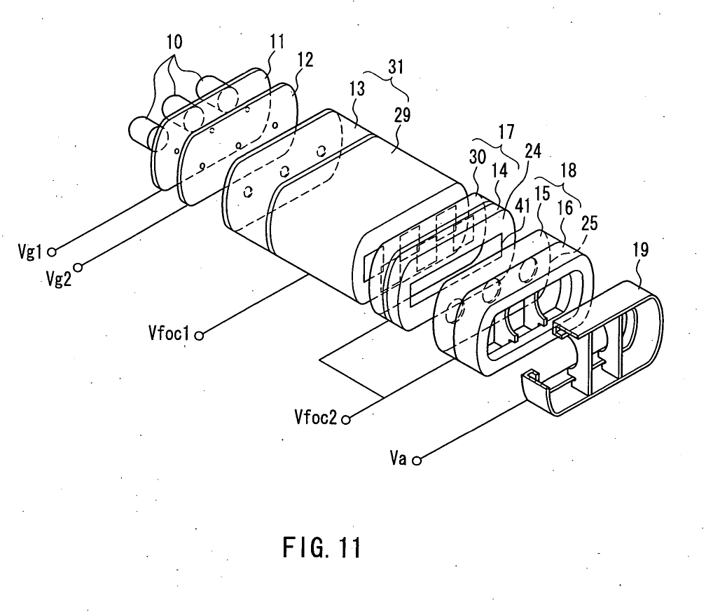

Although the above embodiment has been described using the electron gun with a constant focus voltage, the present invention also is applicable to an electron gun of a dynamic focus type in which the focus voltage varies in a dynamic manner according to deflection. The application of the present invention to the electron gun of a dynamic focus type will be described referring to FIGS. 10 and 11.

An electron gun shown in FIG. 10 includes three cathodes 10, a control electrode 11, an accelerating electrode 12, a first focusing electrode 17, a second focusing electrode 18, a third focusing electrode 31 and an anode electrode 19 in this order. A gap is provided between the first focusing electrode 17 and the second focusing electrode 18. The control electrode 11 is supplied with an electric potential Vg1, the accelerating electrode 12 is supplied with an electric potential Vg2, the first focusing electrode 17 and the second focusing electrode 18 are supplied with equal electric potentials Vfoc1, the third focusing electrode 31 is supplied with an electric potential Vfoc2, which varies in a dynamic manner according to deflection, and the anode electrode 19 is supplied with an electric potential Va. A prefocus lens is formed between the accelerating electrode 12 and the first focusing electrode 17, a quadrupole lens is formed between the second focusing electrode 18 and the third focusing electrode 31, and a main lens is formed between the third focusing electrode 31 and the anode electrode 19. The first focusing electrode 17 is constituted by an electrode part 13 and an electrode part 14, which are both cup-shaped electrodes, the second focusing electrode 18 is constituted by an electrode part 15 and an electrode part 27, which are both cup-shaped electrodes, and the third focusing electrode 31 is constituted by an electrode part 28 and an electrode part 16, which are both cup-shaped electrodes. In the electrode part 14 of the first focusing electrode 17, an opening 41 formed in the electrode surface 24 facing the second focusing electrode 18 is a horizontally elongated single opening common to three electron beams. On the other hand, in the electrode part 15 of the second focusing electrode 18, the electrode surface 25 facing the first focusing electrode 17 is provided with three electron beam passing apertures that are independent of one another.

FIG. 11 is a perspective view showing another example of the electron gun of a dynamic focus type according to the present invention. This electron gun includes three cathodes 10, a control electrode 11, an accelerating electrode 12, a third focusing electrode 31, a first focusing electrode 17, a second focusing electrode 18 and an anode electrode 19 in this order. A gap is provided between the first focusing electrode 17 and the second focusing electrode 18. The control electrode 11 is supplied with an electric potential Vg1, the accelerating electrode 12 is supplied with an electric potential Vg2, the third focusing electrode 31 is supplied with an electric potential Vfoc1, the first focusing electrode 17 and the second focusing electrode 18 are supplied with equal electric potentials Vfoc2, which vary in a dynamic manner according to deflection, and the anode electrode 19 is supplied with an electric potential Va. A prefocus lens is formed between the accelerating electrode 12 and the third focusing electrode 31, a quadrupole lens is formed between the third focusing electrode 31 and the first focusing electrode 17, and a main lens is formed between the second focusing electrode 18 and the anode electrode 19. The third focusing electrode 31 is constituted by an electrode part 13 and an electrode part 29, which are both cup-shaped electrodes, the first focusing electrode 17 is constituted by an electrode part 30 and an electrode part 14, which are both cup-shaped electrodes, and the second focusing electrode 18 is constituted by an electrode part 15 and an electrode part 16, which are both cup-shaped electrodes. In the electrode part 14 of the first focusing electrode 17, an opening 41 formed in the electrode surface 24 facing the second focusing electrode 18 is a horizontally elongated single opening common to three electron beams. On the other hand, in the electrode part 15 of the second focusing electrode 18, the electrode surface 25 facing the first focusing electrode 17 is provided with three electron beam passing apertures that are independent of one another.

In the embodiment described above, out of the first focusing electrode 17 and the second focusing electrode 18 that are spaced away from each other in the tube axis direction and supplied with equal electric potentials, only the electrode surface 24 of the electrode part 14 of the first focusing electrode 17 has been provided with the single opening 41 common to the three electron beams. Instead, only the electrode surface 25 of the electrode part 15 of the second focusing electrode 18 may be provided with the single opening common to the three electron beams. In this case, an effect similar to the above also can be achieved.

### Second Embodiment

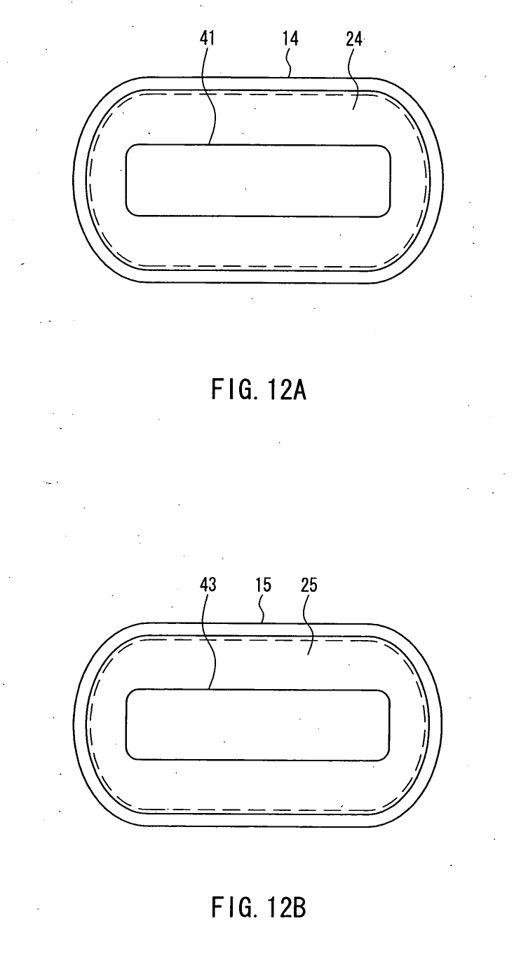

In the first embodiment described above, only one of the electrode surface 24 of the electrode part 14 of the first focusing electrode 17 and the electrode surface 25 of the electrode part 15 of the second focusing electrode 18 that are supplied with equal electric potentials has been provided with the single opening common to the three electron beams. However, as shown in FIGS. 12A and 12B, the electrode surface 24 of the electrode part 14 of the first focusing electrode 17 and the electrode surface 25 of the electrode part 15 of the second focusing electrode 18 respectively may be provided with the single openings 41 and 43 common to the three electron beams. With this configuration, the SVM sensitivity is expected to improve further.

In FIG. 9, a curve c indicates the experimental result of a cathode ray tube device corresponding to the second embodiment, which is equivalent to the cathode ray tube device indicated by the curve b except that the single openings 41 and 43 common to the three electron beams are provided in the electrode parts 14 and 15, respectively. Clearly, the curve c has an improved SVM sensitivity compared with the curve b.

### Third Embodiment

It is desirable that the electrode parts to be provided with a single opening common to the three electron beams should have a cup-like shape. This is because the magnetic flux 23 reaching the cup-like electrode from the SVM coil passes inside a metal material and then is led to the single opening portion. The “cup-like” shape includes not only a shape formed by integral press molding or the like, but also a shape obtained by fixing a bottom plate to a tubular member different from the bottom plate.

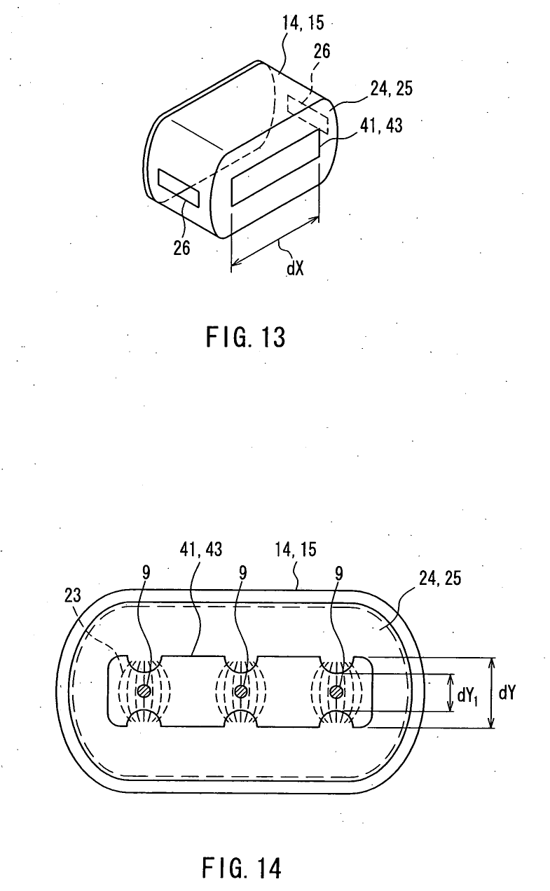

In this case, it is desirable that lateral surface portions that a horizontal axis intersects in the tubular wall surface of the cup-like electrode part should be provided with slits 26 whose longitudinal direction corresponds to the direction parallel with the tube axis direction as shown in FIG. 13. This is because the slits 26 prevent the substantially vertical magnetic flux passing inside the metal portion of the cup-like electrode from passing through these lateral surface portions, so that more magnetic flux can be led to the portion of the single opening 41.

At this time, it is preferable that the horizontal width dX of the opening 41 is extended so as to reach the tubular wall surface. This allows still more magnetic flux to cross the opening 41, thus improving the SVM sensitivity further.

### Fourth Embodiment

In each of the single openings 41 and 43 common to the three electron beams, the vertical width dY₁ near the positions through which the three electron beams 9 pass may be made smaller than the vertical width dY in the other portions as shown in FIG. 14. The single opening of the present embodiment has a structure in which three semi-circular protrusions extending toward the three electron beams 9 passing inside the opening are provided in each of an upper horizontal edge and a lower horizontal edge of the rectangular single opening shown in FIG. 6A, 12A or 12B. This allows more magnetic flux 23 to be led to the vicinity of the electron beams 9, making it possible to enhance the SVM effect further.

### Fifth Embodiment

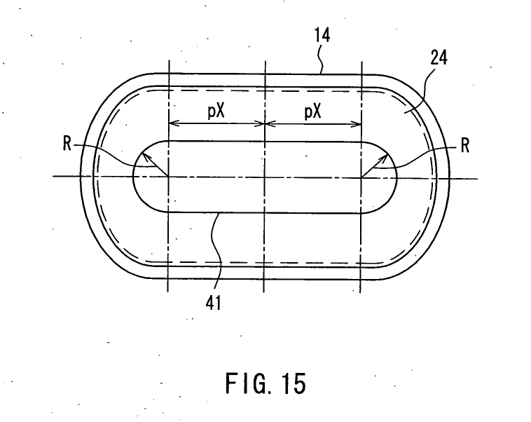

As shown in FIG. 15, both ends of the single opening 41 common to the three electron beams in the horizontal direction may be formed into a circular arc shape (a semi-circular shape).

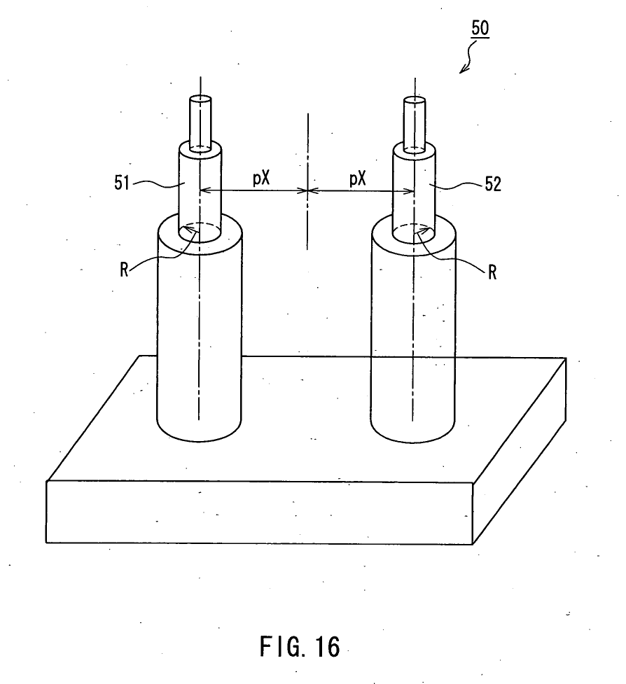

In general, when assembling an electron gun, an assembling jig 50 that is produced relatively easily is used. In the assembling jig 50, two circular cylinders 51 and 52 parallel with each other are provided upright as shown in FIG. 16. The space 2 pX between central axes of the two circular cylinders 51 and 52 coincides with the space between the centers of the outer electron beam passing apertures provided in each electrode of the electron gun.

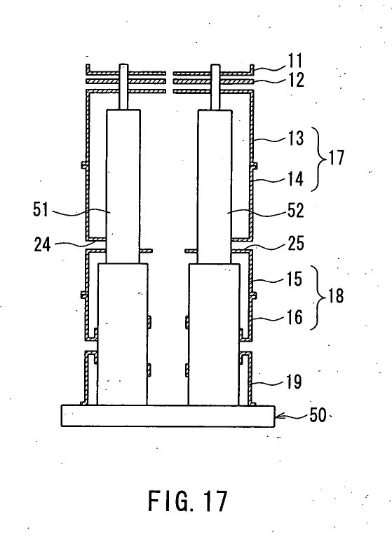

As shown in FIG. 17, the anode electrode 19, the second focusing electrode 18, the first focusing electrode 17, the accelerating electrode 12 and the control electrode 11 are mounted to these two circular cylinders 51 and 52 of the assembling jig 50 and layered in this order via a spacer (not shown) for providing a predetermined gap between adjacent electrodes, thus assembling the electron gun.

In the above assembling process, in the electrode part 14 of the first focusing electrode 17, both ends of the single opening 41 common to the three electron beams formed in the electrode surface 24 facing the second focusing electrode 18 may be formed into a circular arc shape with the same radius R as the circular cylinders 51 and 52, with the space between centers of these circular arc shapes being set as 2 pX. Then, since the first focusing electrode 17 can be positioned accurately in the horizontal direction and the vertical direction by these circular arc shapes at both ends of the opening 41 and the circular cylinders 51 and 52, it is possible to achieve an electron gun with less assembling error and high accuracy.

As described in the second embodiment, in the case where the electrode surface 25 of the electrode part 15 of the second focusing electrode 18 is provided with the single opening 43, it is preferable that the both ends of this single opening 43 are formed into a circular arc shape with a radius R similar to that in FIG. 15. In this manner, the second focusing electrode 18 having the single opening 43 can be positioned accurately in the process of assembling the electron gun.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

What is claimed is:

1. An electron gun comprising:
cathodes;
a control electrode;
an accelerating electrode;
a first focusing electrode;
a second focusing electrode facing the first focusing electrode via a gap, the first focusing electrode and the second focusing electrode being supplied with equal electric potentials; and
an anode electrode;
wherein the cathodes, the control electrode, the accelerating electrode, the first focusing electrode, the second focusing electrode and the anode electrode are disposed in this order, and
an electron beam passing aperture provided in at least one of a surface of the first focusing electrode facing the second focusing electrode and a surface of the second focusing electrode facing the first focusing electrode is a single opening common to three electron beams.

2. The electron gun according to claim 1, wherein an electron beam passing aperture provided in both of the surface of the first focusing electrode facing the second focusing electrode and the surface of the second focusing electrode facing the first focusing electrode is a single opening common to three electron beams.

3. The electron gun according to claim 1, wherein the first focusing electrode or the second focusing electrode provided with the single opening has a tubular wall surface surrounding the three electron beams, and
a hole is provided in lateral surface portions in the wall surface that intersect a horizontal axis.

4. The electron gun according to claim 1, wherein a vertical width of the single opening near positions through which the three electron beams pass is smaller than that at the other positions.

5. The electron gun according to claim 1, wherein both ends of the single opening in a horizontal direction have a circular arc shape.

6. A cathode ray tube device comprising:
a cathode ray tube comprising
an envelope having a front panel and a funnel, and
an electron gun inside a neck portion of the funnel, the electron gun having a first focusing electrode and a second focusing electrode facing the first focusing electrode via a gap, the first focusing electrode and the second focusing electrode being supplied with equal electric potentials; and
a scanning velocity modulation coil provided on an outer surface of the neck portion and near the first focusing electrode and the second focusing electrode;
wherein an electron beam passing aperture provided in at least one of a surface of the first focusing electrode facing the second focusing electrode and a surface of the second focusing electrode facing the first focusing electrode is a single opening common to three electron beams.
